(19) United States
(12) Patent Application Publication
(10) Pub. No.: US 2010/0227026 A1
(43) Pub. Date: Sep. 9, 2010

(54) EDIBLE FAT AND OIL COMPOSITIONS

(75) Inventors: Takeshi Kamegai, Kanagawa (JP); Reiko Ejiri, Kanagawa (JP); Tetsuro Iwasawa, Kanagawa (JP); Michio Kasai, Kanagawa (JP)

Correspondence Address: BUCHANAN, INGERSOLL & ROONEY PC, POST OFFICE BOX 1404, ALEXANDRIA, VA, 22313-1404, US

(73) Assignee: The Nisshin OilliO Group, Ltd., Tokyo (JP)

(21) Appl. No.: 12/681,488

(22) PCT Filed: Oct. 3, 2008
(86) PCT No.: PCT/JP2008/068057

§ 371 Date: Apr. 2, 2010

(30) Foreign Application Priority Data
Oct. 3, 2007 (JP) 2007-260056
Feb. 15, 2008 (JP) 2008-034867

(51) Int. Cl. A23D 9/007; B65D 85/72; A23L 1/01

(52) U.S. Cl. 426/106; 426/607; 426/438

(57) ABSTRACT

The present invention discloses a edible fat and oil composition which suppresses cooked odor of oil. The present invention also discloses an edible fat and oil composition which comprises palm olein having an iodine value of 66 or more and rapeseed oil.

### TECHNICAL FIELD OF THE INVENTION

The present invention relates to edible fat and oil compositions which can effectively suppress cooked odor that is generated when oil is heated.

### BACKGROUND OF THE INVENTION

Edible fats and oils are widely used as a heating medium for use in heat-processing of foods or as a seasoning agent. These fat and oil compositions have a conventionally known problem to be solved that odor is generated by oxidation degradation.

Oxidation degradation is further promoted when fat and oil compositions are exposed to light or high temperature. Such a problem is recognized as an important problem to be solved, particularly when considering storage stability of edible fats and oils.

Various considerations have been made in order to solve this problem. In the following patent literature, the odor in bright light that is generated by photooxidation of an edible fat and oil in a container is suppressed by adding an ultraviolet absorbing agent to the container of a edible fat and oil.

Patent Literature 1: JP-A 7-322819

### DISCLOSURE OF THE INVENTION

However, it was difficult to add an ultraviolet absorbing agent to all kinds of containers of a fat and oil made of different materials and form them as a container.

Thus, it has been desired to develop a technology that the oxidation degradation of a edible fat and oil due to light, etc. can be suppressed even when a edible fat and oil is filled in containers of various materials.

The inventors thoroughly searched to solve the problem and found that oil having nonconventional characteristics can be obtained by combining palm olein and rapeseed oil. More specifically, they found that not only is the cooked odor of oil after being exposed to light suppressed, but the cooked odor of oil before being exposed to light is also suppressed by the above combination. The present invention has been completed based on this finding.

Accordingly, the present invention provides a edible fat and oil composition comprising palm olein having an iodine value of 66 or more and rapeseed oil.

The present invention also provides a edible fat and oil composition comprising palm olein and rapeseed oil, wherein said edible fat and oil composition is filled in a container of 2 L or less, at least a part of which is formed of a light transmissive material.

The present invention further provides a edible fat and oil composition which comprises palm olein having an iodine value of 64 or more and rapeseed oil at a mass ratio of 10:90-80:20, wherein a total amount of the palm olein and the rapeseed oil in the whole edible fat and oil composition is within 50-100 mass %, and said edible fat and oil composition filled in a container having a volume of 2 L or less, at least a part of which is formed of a light transmissive material.

The present invention further provides a method for producing a cooked food which comprises cooking food materials using either one of the above edible fat and oil compositions.

The present invention further provides a food which is produced by using either one of the above edible fat and oil compositions.

### BEST MODE FOR CARRYING OUT THE INVENTION

The edible fat and oil composition of the present invention can be obtained by combining palm olein and rapeseed oil and, optionally other components. Each component and their formulated amounts. etc. are further illustrated below.

### Palm Olein

In the present invention, “palm olein” indicates an edible liquid oil, which is obtained by fractionating and purifying oil collected from a fruit of an oil palm.

Among the above palm olein, palm olein of the edible fat and oil composition of the present invention is preferably selected from those having an iodine value of 66 or more, more preferably those having an iodine value of 66-80, further more preferably those having an iodine value of 66-74, and most preferably those having an iodine value of 66-72. When the iodine value thereof is 66 or more, not only is the cooked odor of oil after being exposed to light suppressed, but the cooked odor of oil before being exposed to light is also suppressed.

The iodine value can be easily measured in accordance with Standard Methods for the Analysis of Fats, Oils and Related Materials 2.3.4.1-1996 (Japan Oil Chemists' Society), for example.

In the present invention, palm olein can be used which comprises, as the constituent fatty acids, fatty acids having 18 carbon atoms and at least one unsaturated bond(s) at an amount of 58-68 mass %, more preferably 60-65 mass %, and most preferably 62-65 mass % in all constituent fatty acids of the palm olein. When the constituent fatty acids of palm olein is within the above range, not only is the cooked odor of oil after being exposed to light further suppressed, but the cooked odor of oil before being exposed to light is also further suppressed.

The above palm olein can be obtained by fractionating palm oil. More specifically, the clusters of oil palm are treated with steam and compressed to produce oil thereof. The produced oil is centrifuged to remove fibers and impurities and dried. Then, the oil is purified by degumming, deacidification, bleaching and deodorization. Examples of the refining method include chemical refining and physical refining, and either of them is usable.

The fractionation method of palm oil for obtaining palm olein is not particularly limited, and natural fractionation by cooling is usually used. It is also possible to use the fractionation method with a surfactant or a solvent. Palm olein is a medium-melting-point part or a low-melting-point part each of which is obtained by fractioning palm oil (a high-melting-point part is generally referred to as palm stearin). This fractionation can be conducted twice or three times, and it is possible to comprise a low-melting-point part obtained by fractionating several times in the edible fat and oil composition of the present invention, particularly those having an iodine value within the above range measured in accordance with the above method.

### Rapeseed Oil

As rapeseed oil used in the present invention, it is possible to use edible rapeseed oil generally distributed. Examples of rapeseed oil include canola oil in which the content of an oleic acid in all constituent fatty acids is less than 70 mass %, and high-oleic low-linolenic canola oil in which the content of an oleic acid in all constituent fatty acids is 70 mass % or more. Taking into account the cost, it is preferable to use canola oil in which the content of an oleic acid in all constituent fatty acids is less than 70 mass %.

### Other Components

In the edible fat and oil composition of the present invention, it is possible to comprise other oils and additives each of which are usually used in edible oils, without departing from the scope of the invention.

Examples of the above oils include generally-used edible oils such as safflower oil, grape seed oil, soybean oil, sunflower oil, corn oil, cotton seed oil, sesame oil, Taihaku sesame oil, rice oil, peanut oil, olive oil, flaxseed oil, transesterified fats and oils, fats and oils having medium-chain fatty acids as constituent fatty acids, and fats and oils having medium-chain fatty acids and long-chain fatty acids as constituent fatty acids. Particularly, when comprising plenty of other oils, it is preferable to use safflower oil, sunflower oil, Taihaku sesame oil, fats and oils having medium-chain fatty acids as constituent fatty acids, or fats and oils having medium-chain fatty acids and long-chain fatty acids as constituent fatty acids.

Examples of the additives include antioxidants, nutrient enrichment agents, emulsifying agents, coloring components and antifoamers.

Examples of the antioxidants include tocopherols, tocotrienols, carotene, flavone derivatives, gallic acid derivatives, catechin and the esters thereof, sesamol and terpenes.

Examples of the nutrient enrichment agents include tocopherols, tocotrienols, phytosterols, esters of phytosetrols, γ-orizanol, astaxanthin, coenzyme Q10, carotene, capsaicin and capsiate.

Examples of the emulsifying agents include polyglycerol esters of fatty acids, polyglycerol esters of polyricinoleic acid, sucrose esters of fatty acids, sorbitan esters of fatty acids, polysorbate, glycerol esters of mono-fatty acids, organic esters of glycerol esters of mono-fatty acids, propylene glycol esters of fatty acids and lecithin.

Examples of antifoamers include fine silica powder and silicone.

In the present specification, examples of tocopherols include α-tocopherol, β-tocopherol, γ-tocopherol and δ-tocopherol. Further, examples of tocotrienols include α-tocotrienol, β-tocotrienol, γ-tocotrienol and δ-tocotrienol.

The edible fat and oil composition of the present invention more preferably comprises carotene among the other components. Examples of carotene include α-carotene and β-carotene. By comprising carotene therein, effects such as maintaining good eyesight during the night and maintaining the health of the skin and mucosa are expected.

The edible fat and oil composition more preferably comprises coenzyme Q10. By comprising coenzyme Q10 therein, higher effects of antioxidant action and antiaging action, etc. are expected to be imparted to the composition. Further, the edible fat and oil composition more preferably comprises tocotrienols. The odor or taste deterioration of the edible fat and oil composition can be suppressed by comprising tocotrienols, due to the antioxidant action thereof on fats and oils. In addition, the edible fat and oil composition can be expected to have the antioxidant action in vivo, the cholesterol-lowering effect and the arteriosclerosis ameliorating effect.

### Formulation of the Edible Fat and Oil Composition

The edible fat and oil composition of the present invention comprises the above palm olein and the rapeseed oil. Though the formulation amount of each component is not particularly limited, the following formulation amount is more preferable in order to accomplish the object of the present invention.

In the edible fat and oil composition of the present invention, the total amount of the palm olein and the rapeseed oil is preferably 50-100 mass %, more preferably 70-100 mass %, and most preferably 90-100 mass %. When the formulation amount of the above two components in the whole edible fat and oil composition is 50 mass % or more, the effects of the present invention can be further enhanced. Namely, not only is the cooked odor of oil after being exposed to light further suppressed, but the cooked odor of oil before being exposed to light is also further suppressed.

Further, in the edible fat and oil composition of the present invention, the mass ratio of the palm olein and the rapeseed oil is preferably 10:90-80:20, more preferably 20:80-80:20, further more preferably 20:80-60:40, further more preferably 20:80-50:50, further more preferably 25:75-45:55, further more preferably 25:75-40:60, further more preferably 30:70-40:60, and most preferably 30:70-35:65. When the mass ratio of the palm olein and the rapeseed oil is within 10:90-80:20, the effects of the present invention can be further enhanced. Namely, not only is the cooked odor of oil after being exposed to light further suppressed, but the cooked odor of oil before being exposed to light is also further suppressed.

When the edible fat and oil composition comprises carotene, the amount of carotene in the whole edible fat and oil composition is 1-600 ppm, preferably 1-400 ppm, and more preferably 5-300 ppm. The above effects of carotene can be more effectively obtained by comprising carotene within the above range.

When the edible fat and oil composition comprises coenzyme Q10, the amount of coenzyme Q10 in the whole edible fat and oil composition is preferably 1-200 ppm. The above effects of coenzyme Q10 can be more effectively obtained by comprising coenzyme Q10 within the above range.

When the edible fat and oil composition comprises tocotrienols, the amount of tocotrienols in the whole edible fat and oil composition is preferably 50-900 ppm. The above effects of tocotrienols can be more effectively obtained by comprising tocotrienols within the above range.

Meanwhile, as for each amount of the above carotene, coenzyme Q10 and tocotrienols, when these components are originally comprised in palm olein or rapeseed oil each of which constitutes the edible fat and oil composition of the present invention, the amounts of the components originally comprised are also added in the calculation of the above numerical values. Therefore, the above numerical values are sometimes accomplished without newly adding the components. Besides, it is also possible to accomplish the above numerical values by adding the above carotene, coenzyme Q10 and tocotrienols as the additives.

### Method for Producing the Edible Fat and Oil Composition

The method for producing the edible fat and oil composition of the present invention is not particularly limited, and the composition is produced by stirring and mixing the palm olein and the rapeseed oil, and, optionally the other components. The order of formulation of such components is not particularly limited. It is possible to heat the components in mixing if necessary.

### Product Forms of the Edible Fat and Oil Composition of the Present Invention

The edible fat and oil composition of the present invention can take any product form. The “product form” indicates a form in which the edible fat and oil composition is filled when transporting, preserving and selling the composition. Examples of product forms of the edible fat and oil composition of the present invention include a plastic bottle, a metallic can and pillow packaging. Since the cooked odor of the edible fat and oil composition of the present invention can be suppressed even after the composition is exposed to light, it is possible to fill it in a container at least part of which is formed of a light transmissive material. The “container at least part of which is formed of a light transmissive material” indicates a container a part of which has permeability that the content therein can be visually confirmed under the fluorescent light. Examples thereof include containers a part or all of which are formed of unpigmented PET, unpigmented lamicon, unpigmented glass, or the like.

Among these containers, the volume of the container is 2 L or less, and preferably 0.5-1.5 L. The edible fat and oil composition which is suitable for home use can be provided by filling the composition in such a container.

### Method for Producing a Cooked Food Using the Edible Fat and Oil Composition of the Present Invention

It is possible to produce a cooked food using the edible fat and oil composition of the present invention. Examples of a cooked food include grilled foods such as broiled meat and okonomiyaki (pancake with meat and vegetables); stir-fries such as fried noodles and stir-fried vegetables; and fries such as tempura, croquettes, fried fish and pork cutlet. In addition, the method for producing a cooked food of the present invention also includes the use of the edible fat and oil composition as demolding oil.

Specifically, the method comprises the steps of adding appropriate quantities of the edible fat and oil composition to a cooking utensil and heating it, adding food materials thereto, and cooking them by grilling, stir-frying or deep frying. It is possible to change as appropriate an amount of the edible fat and oil composition, heating temperature and cooking time depending on a kind of used foods, food preparation method, or the like.

A food which is Produced by Using the Edible Fat and Oil Composition of the Present Invention

Examples of the food produced by using the edible fat and oil composition of the present invention include seasoning agents, foods produced by the above method for producing the cooked foods such as grilled foods, stir-fries and fries, boiled foods and marinated foods.

Examples of the content of the edible fat and oil composition of the present invention in food are 10-80 mass % in a seasoning agent, 1-20 mass % in a grilled food, 1-20 mass % in a stir-fry, 1-40 mass % in a fry, 1-10 mass % in a boiled food, and 5-50 mass % in a marinated food.

It is possible that not only is the cooked odor of oil after being exposed to light suppressed, but the cooked odor of oil before being exposed to light is also suppressed by the edible fat and oil composition of the present invention. Therefore, it becomes possible to produce cooked foods which smell good and taste good by using the edible fat and oil composition of the present invention.

The following Examples will further illustrate the present invention. They only explain the present invention and do not particularly limit the invention.

### EXAMPLES

“%” and “part” mentioned below indicate “mass %” and “part by weight” respectively unless specified otherwise. The iodine value is a value measured in accordance with the method of “Standard Methods for the Analysis of Fats, Oils and Related Materials 2.3.4.1-1996 (Japan Oil Chemists' Society)”.

### Determination of a Cooked Odor of a Edible Fat and oil Composition After Being Exposed to Light

### Edible Fat and Oil Compositions Used

The evaluation was conducted using the following fats and oils alone or in the formulation as indicated in Table 1 below:

Palm olein [iodine value 60] (trade name: Super Olein (S), produced by The Nisshin OilliO Group, Ltd., a content of fatty acids having 18 carbon atoms and at least one unsaturated bond(s) in all constituent fatty acids: 56.6 mass %);

Palm olein [iodine value 68] (produced by Intercontinental Specialty Fats SDN. BHD, a content of fatty acids having 18 carbon atoms and at least one unsaturated bond(s) in all constituent fatty acids: 63.1 mass %, a content of an oleic acid in all constituent fatty acids: 48.4 mass %, a content of a linoleic acid in all constituent fatty acids: 14.4 mass %, a content of a linolenic acid in all constituent fatty acids: 0.3 mass %); and

Canola oil (rapeseed oil)(trade name: Nisshin Canola Oil, produced by The Nisshin OilliO Group, Ltd., a content of an oleic acid in all constituent fatty acids: 61.0 mass %, a content of a linoleic acid in all constituent fatty acids: 19.6%, a content of a linolenic acid in all constituent fatty acids: 10.3 mass %).

### Condition of Light Exposure

The light exposure of the fat and oil composition was conducted in accordance with the following method. 1000 g of the fat and oil composition of the Table 1 below was filled in an unpigmented PET container (for filling 1000 g of oil). Then, the unpigmented PET container in which the edible fat and oil composition was filled was exposed to light of 7000 Lux with a fluorescent lamp for 16 hours to obtain oil after being exposed to light.

### Specific Method of Determination

100 g of each sample of Table 1 was weighed and poured in a 200 mL beaker, heated up to 180° C., and the generated odor thereof was evaluated. Each of oil before being exposed to light (“oil not exposed to light” in Table 1) and oil after being exposed to light in accordance with the above method (“oil exposed to light” in Table 1) was prepared as the heated edible fat and oil composition of which odor is evaluated.

The evaluation was conducted as follows. 10 panelists checked the cooked odor of the oil and judged it in accordance with the following evaluation standards. Then, evaluation results of 10 panelists were averaged to obtain the evaluation result of the odor each edible fat and oil composition has.

### Evaluation Standards

10-8: feeling almost no cooked odor
Less than 8-6: feeling some cooked odor
Less than 6-4: feeling pungent cooked odor
Less than 4: feeling strong pungent odor

### Results

TABLE 1

| | Example | | | | | | | Comp. Exam. | | |
|---|---|---|---|---|---|---|---|---|---|---|
| Sample | 1 | 2 | 3 | 4 | 5 | 6 | 7 | 1 | 2 | 3 |
| Palm olein [iodine val. 60] | | | | | | | | | | 100 |
| Palm olein [iodine val. 68] | 20 | 25 | 30 | 35 | 40 | 50 | 60 | 100 | | |
| Canola oil | 80 | 75 | 70 | 65 | 60 | 50 | 40 | | 100 | |
| Total | 100 | 100 | 100 | 100 | 100 | 100 | 100 | 100 | 100 | 100 |
| Oil not exposed to light | 8.5 | 8.5 | 8.7 | 9.0 | 9.0 | 8.5 | 8.5 | 8.0 | 7.6 | 7.8 |
| Oil exposed to light | 8.0 | 8.1 | 8.6 | 8.5 | 8.0 | 8.0 | 8.0 | 6.6 | 6.0 | 6.5 |

As indicated in Table 1, in Examples within the scope of the present invention, it can be confirmed that the cooked odor of each of oil not exposed to light and that exposed to light is suppressed.

On the contrary, in Comparative Examples in which palm olein or canola oil was used alone, it can be confirmed that even the oil not exposed to light generated some cooked odor. Further, it was confirmed that more cooked odor of the oil after being exposed to light was generated as compared to that of the fat and oil composition of the present invention.

### Analysis of Odor Component Generated in a Head Space of a Vial Container in Heating

The following test was conducted in order to quantitatively analyze the odor which was generated in heating the edible fat and oil composition as mentioned above.

2 g of each sample of Table 2 below was poured in a 10 mL vial container and stirred with heating at 180° C. for 10 minutes. Then, the odor component generated in a head space of the vial container was analyzed with GC-MS (trade name: GC-MSD System, produced by Hewlett-Packard, used column: DB-WAX (J&W), carrier gas: helium, temperature analysis). In the analysis, acrolein which is a volatile component and also an index of the odor of oil was indicated as the peak area ratio of GC-MS chromatogram (area ratio when defining the peak area of canola oil as 1.0). The results are shown in Table 2 below.

TABLE 2

| Sample | Example 8 | Comp. Ex. 4 |
|---|---|---|
| Canola oil | 70 | 100 |
| Palm olein └iodine val. 68┘ | 30 | |
| Area ratio | 0.8 | (1.0) |

As indicated in above Table 2, Example 8 within the scope of the present invention generates less acrolein as compared to Comparative Example 4, and it can suppress the cooked odor of oil.

Production of Fries Using the Edible Fat and Oil Composition of the Present Invention, and Evaluation of Odor and Taste of the Fries Produced with the Fat and Oil Composition Exposed to Light or Not Exposed to Light

### (1) Oil Used

1000 g each of the oils of Example 8 and Comparative Example 4 was filled in an unpigmented PET container and exposed to light of 1000 Lux with a fluorescent light for 3 weeks. Then, each oil exposed to light was used in the evaluation. (2) Method for Producing Fries

Fries were produced using the oil exposed to light. More specifically, fries of horse mackerel were prepared using the oil exposed to light.

The fries of horse mackerel were produced by the method comprising the steps of heating each 1000 g of the oils up to 180° C., and frying frozen horse mackerel with bread crumbs therein for 4 minutes.

(3) Evaluation of the Produced Fries

The fries were evaluated by 12 panelists who ate the fries. They ate both the fries of horse mackerel using the oil exposed to light of Example 8 and those using the oil exposed to light of Comparative Example 4, and selected the fries which smelled better and tasted better.

(4) Evaluation Results

All of 12 panelists judged that the fries of horse mackerel using the oil exposed to light of Example 8 smelled better and tasted better than those using the oil exposed to light of Comparative Example 4.

### Measurement of Amounts of Tocotrienols and Coenzyme Q10

Each amount of tocotrienols and coenzyme Q10 was measured in each of the edible fat and oil compositions which were formulated as indicated in Table 3 below. The measured amount of tocotrienols is a total amount of α-tocotrienol, β-tocotrienol, γ-tocotrienol and δ-tocotrienol.

The palm olein used is a prototype of The Nisshin OilliO Group, Ltd., which has an iodine value of 69 and comprises fatty acids having 18 carbon atoms and at least one unsaturated bond(s) at an amount of 63.4 mass % in all constituent fatty acids. The canola oil used is Nisshin Canola Oil (trade name) produced by The Nisshin OilliO Group, Ltd., which comprises 61 mass % of an oleic acid in all constituent fatty acids. Each amount of the tocotrienols and coenzyme Q10 in the fats and oils was measured with HPLC.

TABLE 3

| | | tocotrienols | coenzyme |
|---|---|---|---|
| | | (ppm) | Q10 (ppm) |
| Comp. Ex. 5 | Palm olein (iodine value 69) | 440 | 2.2 |
| Comp. Ex. 6 | Canola oil | 0 | 0 |
| Comp. Ex. 9 | Palm olein (i.v. 69):Canola | 100 | 0.4 |
| | oil = 20:80 | | |
| Ex. 10 | Palm olein (i.v. 69):Canola | 125 | 0.6 |
| | oil = 25:75 | | |
| Ex. 11 | Palm olein (i.v. 69):Canola | 150 | 0.7 |
| | oil = 30:70 | | |
| Ex. 12 | Palm olein (i.v. 69):Canola | 175 | 0.8 |
| | oil = 35:65 | | |
| Ex. 13 | Palm olein (i.v. 69):Canola | 200 | 0.9 |
| | oil = 40:60 | | |
| Ex. 14 | Palm olein (i.v. 69):Canola | 250 | 1.1 |
| | oil = 50:50 | | |
| Ex. 15 | Palm olein (i.v. 69):Canola | 300 | 1.3 |
| | oil = 60:40 | | |

1. An edible fat and oil composition comprising palm olein having an iodine value of 66 or more and rapeseed oil.

2. The edible fat and oil composition according to claim 1, wherein the total amount of the palm olein and the rapeseed oil in the whole edible fat and oil composition is 50-100 mass %.

3. The edible fat and oil composition according to claim 1, wherein the mass ratio of the palm olein and the rapeseed oil is 10:90-80:20.

4. The edible fat and oil composition according to claim 1, wherein the iodine value of the palm olein is 66-80.

5. The edible fat and oil composition according to claim 1, wherein the composition is filled in a container at least a part of which is formed of a light transmissive material.

6. The edible fat and oil composition according to claim 5, wherein the volume of the container is 2 L or less.

7. A edible fat and oil composition comprising palm olein and rapeseed oil, wherein the composition is filled in a container of 2 L or less, at least a part of which is formed of a light transmissive material.

8. The edible fat and oil composition according to claim 7, wherein the composition comprises palm olein having an iodine value of 64 or more and rapeseed oil at a mass ratio of 10:90-80:20, and wherein the total amount of the palm olein and the rapeseed oil in the whole edible fat and oil composition is 50-100 mass %.

9. The edible fat and oil composition according to claim 1, further comprising carotene.

10. The edible fat and oil composition according to claim 1, further comprising coenzyme Q10.

11. The edible fat and oil composition according to claim 1, further comprising tocotrienols.

12. A method for producing a cooked food which comprises cooking food materials using the edible fat and oil composition according to claim 1.

13. A food produced by using the edible fat and oil composition according to claim 1.
